(19) United States
(12) Patent Application Publication
(10) Pub. No.: US 2025/0086879 A1
(43) Pub. Date: Mar. 13, 2025

(54) VOXEL OCCUPANCY BASED OBJECT PLACEMENT IN EXTENDED REALITY XR ENVIRONMENT

(71) Applicant: SAMSUNG ELECTRONICS CO., LTD., Suwon-si (KR)

(72) Inventor: Lakshmi Priya MURALEEDHARAN, Bengaluru (IN)

(73) Assignee: SAMSUNG ELECTRONICS CO., LTD., Suwon-si (KR)

(21) Appl. No.: 18/954,087

(22) Filed: Nov. 20, 2024

Related U.S. Application Data
(63) Continuation of application No. PCT/IB2024/058614, filed on Sep. 5, 2024.

(30) Foreign Application Priority Data
Sep. 5, 2023 (IN) 202341059478

(51) Int. Cl. G06T 15/08

(52) U.S. Cl. CPC G06T 15/08

(57) ABSTRACT

Provided is a method for object placement in an XR environment by a XR apparatus. The method includes determining a voxel occupancy of a first position of a first object available in a virtual scene; receiving a user input including a second position for placing a second object in the virtual scene; determining a voxel occupancy for the second object for placing the second object in the second position; determining a voxel space in-between the first position of the first object and the second position of the second object based on the voxel occupancy of the first object and the voxel occupancy of the second object; and displaying at least one recommendation to place the second object in the virtual scene based on the voxel space in-between the first position of the first object and the second position of the second object.

### CROSS-REFERENCE TO RELATED APPLICATION(S)

This application is a continuation application, claiming priority under § 365(c), of an International Application No. PCT/IB2024/058614, filed on Sep. 5, 2024, which is based on and claims priority to Indian patent application Ser. No. 202341059478, filed on Sep. 5, 2023, in the Indian Intellectual Property Office, the disclosures of which are incorporated by reference herein in their entireties.

### BACKGROUND

### 1. Field

The present disclosure relates to the field of an extended reality XR method and system, and more particularly to a method and an XR apparatus for voxel occupancy based object placement in an XR environment.

### 2. Description of Related Art

In related methods and systems, a virtual object placement technique intentions at generating visually pleasing placement of virtual objects by removing undesirable cluttered placement of objects. In virtual reality VR)/AR experiences, smartphones/HMDs are handheld/head-mounted in various static and dynamic modes, with a limited field of view not encompassing the entire 3D space. In related methods and systems, there is no alternative mechanism of suggestion to the users for object placement based on a cluttered scene. Related methods use scene understanding for virtual object placement suggestion. But existing methods will not be able to tackle cluttering of the scene when multiple instances of same object category appears in the scene.

Because of fixed selection of parameters and restricted field of view during location estimation, the existing method does not result in optimal placement. This results in cluttered object placement in the virtual scene. Constant restriction in the field of view during the object placement, the existing method results in the loss of important details across the periphery of the frames.

In related methods for stabilization, either no suggestion is provided to the user, making it possible to place objects anywhere or some recommendation is given based on scene understanding. The related methods do not prevent overcrowding or cluttering of the virtual objects.

In an example, if the person is static and continuously placing objects in a same camera view finally the placing objects in the same camera view leads to no more space in the camera view. In an example, there is a better chance of clutter free arrangement of the objects if the camera view is changed elsewhere. In another example, there is need for there to be a suggestion mechanism to help the user for clutter free placement with minimum displacement of the camera. In another example, in order to suggest camera displacement, the user of the XR apparatus may need to have a space management mechanism which is light weight and fast. In an example, The user might feel more ease if simple instructions are given like “move left”, “move right” etc. In an example, In order to recommend alternate camera view, the current space utilization needs to be maintained and dynamically updated too. But, the existing method does not support the above mentioned feature.

It is desired to address the above mentioned disadvantages or other short comings or at least provide a useful alternative.

### SUMMARY

Accordingly, the embodiments herein disclose a method for object placement in an XR environment. The method may be executed by at least one processor in a XR apparatus and may include determining a voxel occupancy of a first position of a first object available in a virtual scene; receiving a user input including a second position for placing a second object in the virtual scene; determining a voxel occupancy for the second object for placing the second object in the second position; determining a voxel space in-between the first position of the first object and the second position of the second object based on the voxel occupancy of the first object and the voxel occupancy of the second object; and displaying at least one recommendation to place the second object in the virtual scene based on the voxel space in-between the first position of the first object and the second position of the second object.

Accordingly, the embodiments herein disclose a XR apparatus for object placement in an XR environment. The XR apparatus includes memory; at least one processor; a display; and an object placement controller, communicatively coupled to the memory, the at least one processor, and the display, configured to: determine a voxel occupancy of a first position of a first object available in a virtual scene, receive a user input including a second position for placing a second object in the virtual scene, determine a voxel occupancy for the second object for placing the second object in the second position, determine a voxel space in-between the first position of the first object and the second position of the second object based on the voxel occupancy of the first object and the voxel occupancy of the second object, and display at least one recommendation on the display to place the second object in the virtual scene based on the voxel space in-between the first position of the first object and the second position of the second object.

Accordingly, the embodiments herein disclose a non-transitory computer-readable storage medium storing one or more instructions, that when executed by at least one processor, cause an extended reality XR device to determine a voxel occupancy of a first position of a first object available in a virtual scene, receive a user input including a second position for placing a second object in the virtual scene, determine a voxel occupancy for the second object for placing the second object in the second position, determine a voxel space in-between the first position of the first object and the second position of the second object based on the voxel occupancy of the first object and the voxel occupancy of the second object, and display at least one recommendation on the display 550 to place the second object in the virtual scene based on the voxel space in-between the first position of the first object and the second position of the second object.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the scope thereof, and the example embodiments herein include all such modifications.

### BRIEF DESCRIPTION OF THE DRAWINGS

Embodiments of the present disclosure are illustrated in the accompanying drawings, throughout which like reference letters indicate corresponding parts in the various figures. The embodiments herein will be better understood from the following description with reference to the drawings, in which:

FIG. 1 and FIG. 2 are example illustrations in which a 3D space generation is depicted, according to related art;

FIG. 3 is an example illustration in which a video stabilization pipeline is depicted, according to related art;

FIG. 4 is a flow chart illustrating a scene understanding object placement method, according to related art;

FIG. 5 illustrates various hardware components of an XR apparatus, according to an embodiment;

FIG. 6 illustrates various hardware components of an object placement controller included in the XR apparatus, according to an embodiment as disclosed herein;

FIG. 7 is an example illustration in which a 3D occupancy grid is depicted, according to an embodiment;

FIG. 8 is an example illustration in which a ray hit test is depicted, according to an embodiment;

FIG. 9 is an example illustration in which placement decision is depicted, according to an embodiment;

FIG. 10 is an example illustration in which ray hit test query for alternate view suggestion is depicted, according to an embodiment;

FIG. 11 is a flow chart illustrating a process for an object placement in an XR environment, according to an embodiment;

FIG. 12 is an example flow chart illustrating a process for the object placement in the XR environment, according to an embodiment;

FIG. 13 is an example illustration in which a user suggestion for the object placement in the virtual space is depicted, according to an embodiment;

FIG. 14 is an example illustration in which walking around scenario, space is left and few more objects are added in a drawing room, according to an embodiment;

FIG. 15 is an example illustration in which no space left in current view to add objects in a dining room, according to an embodiment; and

FIG. 16 is an example illustration in which walking around scenario, no more space is left to add more objects while preserving space to walk around in a drawing room, according to an embodiment.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### DETAILED DESCRIPTION

A first object of the embodiments herein is to disclose a method, a process, and an XR apparatus for voxel occupancy based object placement in an XR environment.

Another object of the embodiments herein is to measure voxel occupancy of a new object being placed along with existing objects to recommend alternate position and/or orientation for the new object in the XR environment.

Another object of the embodiments herein is to determine a voxel space in-between a position of a first object and a position of a second object based on a voxel occupancy of the first object and the voxel occupancy of the second object.

Another object of the embodiments herein is to display a recommendation to place the second object in the virtual scene based on the voxel space.

Another object of the embodiments herein is to display a directional indicia indicating the alternate position to place the second object in the virtual space.

Another object of the embodiments herein is to provide a recommendation of object placement direction based on a current camera view based on a current occupancy grid.

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor e.g., one or more programmed microprocessors and associated circuitry, or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The embodiments herein achieve a method and/or process for object placement in an XR environment. The method includes determining, by a XR apparatus, a voxel occupancy of a first object available in a virtual scene. A voxel may be a volumetric pixel, voxel occupancy may be a measure of and/or a dimensionality descriptor for a three-dimensional space, and voxel space may be a rendering of a three-dimensional space generated by casting rays from a camera location. Further, the method includes receiving, by the XR apparatus, a user input including a position for placing a second object in the virtual scene. Further, the method includes determining, by the XR apparatus, a voxel occupancy for the second object for placing the second object in the position of the second object provided in the user input. Further, the method includes determining, by the XR apparatus, a voxel space in-between a position of the first object and the position of the second object based on the voxel occupancy of the first object and the voxel occupancy of the second object. Further, the method includes displaying, by the XR apparatus, at least one recommendation to place the second object in the virtual scene based on the voxel space.

Unlike conventional methods and systems, the method disclosed herein can be used to adjust the parameters and field of view based on the current objects placement in a dynamic manner. The method can be used to estimate the current objects in the 3D space and generate an alternate view suggestion also known as score-threshold based technique to propose the placement of the new object in an effective manner, so as to provide a better use experience to novice users. The disclosed method can be used to generate fast and good quality suggestion of alternate locations for the object placement by dynamically adapting placement suggestion of the object based on the current objects in field or analyzing a pixel area of the second object. The disclosed method can be used to dynamically provide a feedback to the user to adjust position of the second object to generate clutter free XR space, so as to improve the quality of user experience and object placement in the XR apparatus.

Based on the disclosed method, there is a better chance of clutter free arrangement of objects if the camera view is changed elsewhere. There is need for a suggestion mechanism to help the user for clutter free placement with minimum displacement of camera. In order to suggest camera displacement, the method can be used to have a space management mechanism which is light weight and fast. The user might feel more ease if simple instructions are given like “move left”, “move right” etc. In order to recommend alternate camera view, the current space utilization may need to be maintained and dynamically updated too.

The disclosed method provides the occupancy map for the 3D field under consideration and uses the occupancy map to suggest location for placement of objects or choose alternate field of view. The disclosed method enables the better user experience by reducing the constraints of limited field of view. The disclosed method dynamically updates the occupancy matrix to assist the placement of objects in the multiuser scenario.

Based on the disclosed method, the volumetric analysis assists for the space management and the user interactions. The disclosed method helps the user to analyse the space available for his/her future additions of virtual objects. Similarly the existing information about space availability can be used to analyse actions possible on the virtual space/XR space to perform actions such as walking around, easy gestures etc., without impacting the real/virtual objects. According to the current filled space information, the disclosed method can detect for a fixed number of actions e.g.: path for walking around, moving hands in surrounding etc., when there is enough space to perform that action. The method can be used for detecting the reachability and the visibility when the new virtual object is getting placed at a location. In an example, placing a coffee mug in a new location in an office space, when important objects like laptop, mouse etc. gets visually blocked by the new object.

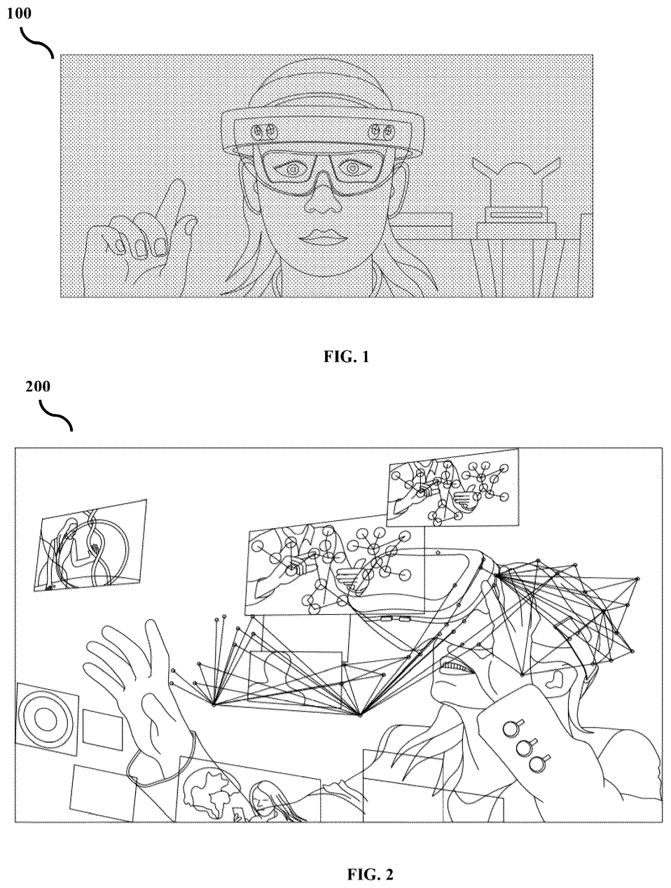

FIG. 1 and FIG. 2 are example illustrations 100 and 200 respectively, in which a three dimensional 3D space generation is depicted, according to related art. In general, a user of an XR apparatus in a 3D space generates lot of contents such as 3D models of indoor objects e.g.: household objects like table, chair etc. imported from a library, 3D sketches e.g.: 3D art/sketch like augmented reality AR doodle or the like generated by the user, 3D stickers e.g., AR stickers from a library, 3D text input e.g.: Hello World! by the user, 3D picked objects using image to mesh generation e.g.: AR picking or the like, 3D virtual avatar/assistant e.g.: AR emoji. In such a use case, the problems are too many options of contents to be placed by the user and too less space in a viewport of the XR apparatus. The user of the XR apparatus may keep generating content localized in a same region throughout in a XR session leading to reduced visibility to the user of the XR apparatus. Since, an object placement is an integral part of an XR pipeline in the XR apparatus, poorer placement reduces an end user experience.

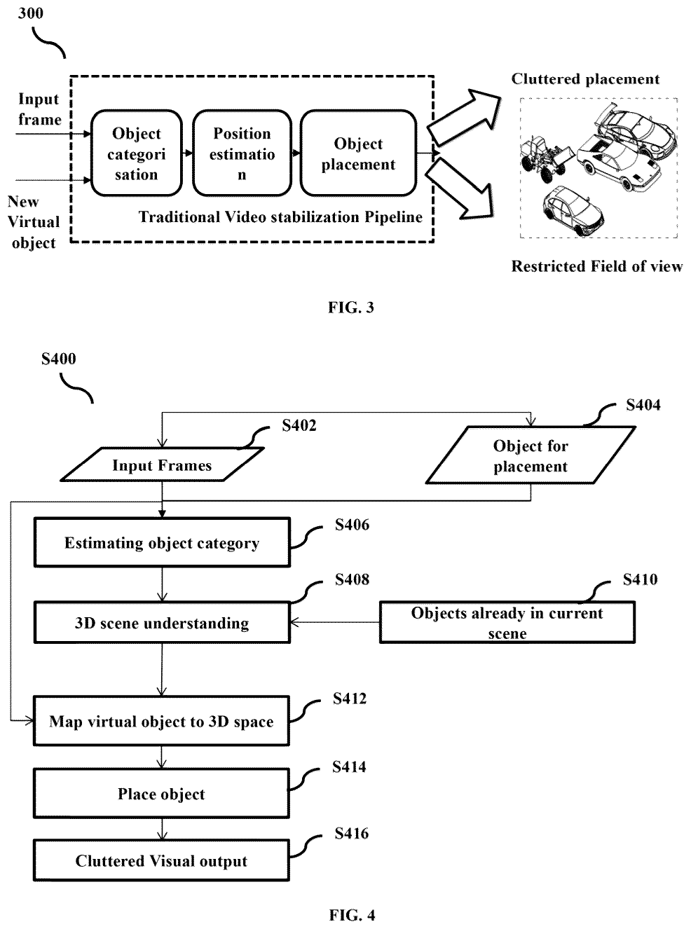

FIG. 3 is an example illustration 300 in which a video stabilization pipeline is depicted, according to related art. In an example, the current object placement techniques in the XR engines use camera view parameters to estimate depth and define the location of placing the virtual object in the 3D scene. Multiple users may place the objects in a relatively closer space, so that choosing an optimal location which results in clutter free 3D space is challenging. There are no existing methods which restrict the users in repeated placement of the objects in relatively closer space. Apart from the restriction in the placement, suggestion of possible space for object placement is also an important aspect for better user experience. The existing methods do not suggest the possible space for the object placement

FIG. 4 is a flow chart S400 illustrating a scene understanding object placement method, according to art. At operation S402, the method includes inputting frames of the XR scene. At operation S404, the method includes receiving an input for placing the object in the XR scene. At operation S406, the method includes estimating an object category. At operation S408, the method includes receiving an input corresponding to the existing objects already in the current scene. At operation S410, the method includes understanding the 3D scene. At operation S412, the method includes mapping virtual object to the 3D space. At operation S414, the method includes placing the new object, and At operation S416, the method includes outputting the cluttered XR scene.

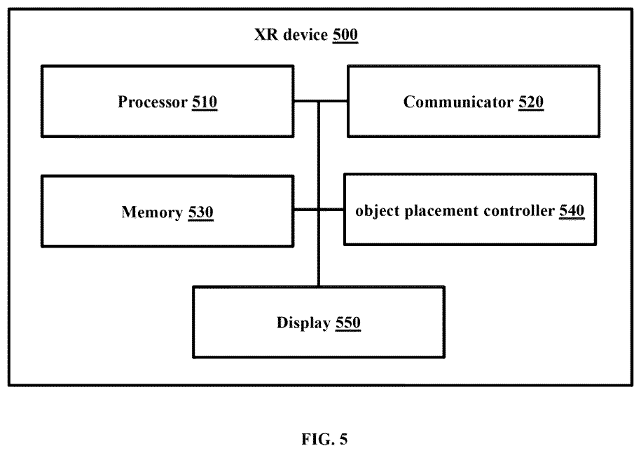

Referring now to the drawings, and more particularly to FIGS. 5 through 16, where similar reference characters denote corresponding features consistently throughout the figures, there are shown example embodiments.

FIG. 5 shows various hardware components of an XR apparatus 500, according to an embodiment as disclosed herein. The XR apparatus 500 also known as an Augmented Reality AR apparatus, a Mixed Reality MR apparatus, a Virtual Reality VR apparatus, and a metaverse apparatus. The XR apparatus 500 can be, for example, but not limited to a laptop, a notebook, a smartphone, a foldable phone, a smart TV, a tablet, an immersive device, a Virtual Studio Technology VST headset, and an internet of things IoT device. In an embodiment, the XR apparatus 500 includes a processor 510, a communicator 520, a memory 530, an object placement controller 540, and a display 550. The processor 510 is communicatively coupled with the communicator 520, the memory 530, the object placement controller 540, and the display 550).

The object placement controller 540 determines a voxel occupancy of a first object e.g., furniture, wall, light, or the like available in a virtual scene. In an embodiment, the voxel occupancy is used to reconstruct a 3-dimensional shape of the object from multiple view. In an embodiment, the object placement controller 540 displays a 360 degree camera view of the virtual scene on the display 550. Further, the object placement controller 540 generates a 3D map based on a 3D spatial partitioning of the 360 degree camera view of the virtual scene. The 3D voxel space includes a plurality of voxels each of which represents whether at least one portion of the first object lies in the 3D voxel space. Further, the object placement controller 540 determines mesh coordinates of each voxel of the plurality of voxels and imaging sensor parameters of the XR apparatus 500. Further, the object placement controller 540 determines the voxel occupancy of the first object available in the virtual scene based on the mesh coordinates of each voxel of the plurality of voxels and the imaging sensor parameters of the XR apparatus 500).

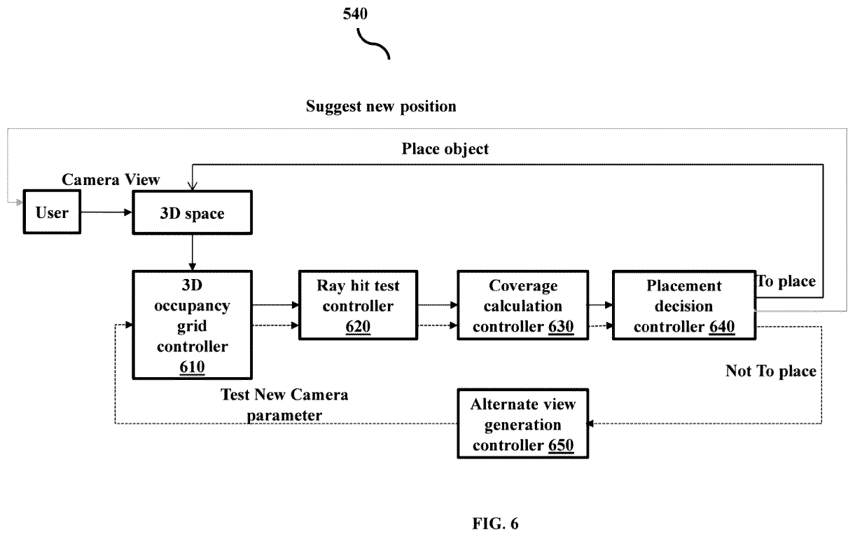

Further, the object placement controller 540 receives a user input including a position for placing a second object e.g., furniture, laptop, TV, wall, light, or the like in the virtual scene. Further, the object placement controller 540 determines a voxel occupancy for the second object for placing the second object in the position of the first object provided in the user input. In an embodiment, the object placement controller 540 displays the 360 degree camera view of the virtual scene on the display 550. Further, the object placement controller 540 generates the 3D map based on the 3D spatial partitioning of the 360 degree camera view of the virtual scene. The 3D voxel space includes the plurality of voxels each of which represents whether a portion of the first object lies in the 3D voxel space. Further, the object placement controller 540 determines the number of voxels of the plurality of voxels that are occupied by the second object in the virtual scene by performing a hit test explained in FIG. 6 for each voxel of the plurality of voxels based on the position of the second object provided in the user input. Further, the object placement controller 540 determines the voxel occupancy for the second object in the user selected position based on the number of voxels that are occupied by the second object in the virtual scene.

Further, the object placement controller 540 determines a voxel space in-between a position of the first object and the position of the second object based on the voxel occupancy of the first object and the voxel occupancy of the second object.

Based on the voxel space, the object placement controller 540 displays a recommendation on the display 550 to place the second object in the virtual scene. In an embodiment, the object placement controller 540 determines whether the voxel space in-between the positions of the first object and the second object meets a voxel space threshold. Further, the object placement controller 540 determines the recommendation to place the second object in the virtual scene based on a category of the second object, when the voxel space in-between the positions of the first object and the second object meets the voxel space threshold e.g., object placement threshold. The object placement threshold may vary according to the scene context. In an example, the number of objects that can be placed and hence the threshold will be different in an office room setting versus a drawing room. The user interactions are different in both contexts. The XR apparatus 500 uses an Artificial intelligence AI driven methodology to understand the scene based on the indoor classification. The object threshold is decided based on a data driven approach from datasets of a user feedback in an AR session. The reason is that the body movements and the user interaction would be limited in some scenarios like office whereas it might be more interactive such as walking around in the drawing room. Hence the threshold parameters must vary according to the scenario.

In an embodiment, the recommendation to place the second object in the virtual scene is determined by capturing a ray in one or more angles with respect to a current camera angle, estimating voxels covered in each of the angles, determining the voxel occupancy for the optimal orientation of the XR apparatus 500 in each of the angles based on the voxels covered in each of the angles, and determining the recommendation to place the second object in the virtual scene based on voxel occupancy for the optimal orientation of the XR apparatus 500 and the category of the second object. Further, the object placement controller 540 displays the recommendation to place the second object in the virtual scene.

The recommendation can be, for example, but not limited to an alternate position to place the second object and the optimal orientation of the XR apparatus 500 for placement of the second object in the virtual scene. The alternate position may be beyond a current field of view of the XR apparatus 500. In the same of another embodiment, the object placement controller 540 displays a directional indicia indicating the alternate position to place the second object in the virtual space.

Further, the object placement controller 540 determines the voxel space threshold using an AI model. In an embodiment, the object placement controller 540 determines semantic parameters of a plurality of scenes, semantic parameters of objects in each scene of the plurality of scenes, a type user interaction with objects in each scene of the plurality of scenes, and a correlation between voxel space and the user interactions with objects in each scene of the plurality of scenes. Further, the object placement controller 540 trains the AI model based on the semantic parameters of the plurality of scenes, the semantic parameters of objects in each scene of the plurality of scenes, the type user interaction with objects in each scene of the plurality of scenes, and the correlation between voxel space and the user interactions.

The object placement controller 540 is physically implemented by analog or digital circuits such as logic gates, integrated circuits, microprocessors, microcontrollers, memory circuits, passive electronic components, active electronic components, optical components, hardwired circuits, or the like, and may be driven by firmware.

Further, the processor 510 is configured to execute instructions stored in the memory 530 and to perform various processes. The communicator 520 is configured for communicating internally between internal hardware components and with external devices via one or more networks. The memory 530 also stores instructions to be executed by the processor 510. The memory 530 may include non-volatile storage elements. Examples of such non-volatile storage elements may include magnetic hard discs, optical discs, floppy discs, flash memories, or forms of electrically programmable memories EPROM or electrically erasable and programmable EEPROM memories. In addition, the memory 530 may, in some examples, be considered a non-transitory storage medium. The term “non-transitory” may indicate that the storage medium is not embodied in a carrier wave or a propagated signal. However, the term “non-transitory” should not be interpreted that the memory 530 is non-movable. In certain examples, a non-transitory storage medium may store data that can, over time, change e.g., in Random Access Memory RAM or cache.

Further, at least one of a plurality of modules/controller may be implemented through the AI model using a data driven controller. The data driven controller can be a ML model based controller and an AI model based controller. A function associated with the AI model may be performed through a non-volatile memory, a volatile memory, and the processor 510. The processor 510 may include one or a plurality of processors. At this time, one or a plurality of processors may be a general purpose processor, such as a central processing unit CPU, an application processor AP, or the like, a graphics-only processing unit such as a graphics processing unit GPU, a visual processing unit VPU, and/or an AI-dedicated processor such as a neural processing unit NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network CNN, deep neural network DNN, recurrent neural network RNN, restricted Boltzmann Machine RBM, deep belief network DBN, bidirectional recurrent deep neural network BRDNN, generative adversarial networks GAN, and deep Q-networks.

The learning algorithm is a method for training a predetermined target device for example, a robot using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 5 shows various hardware components of the XR apparatus 500 but it is to be understood that other embodiments are not limited thereon. In other embodiments, the XR apparatus 500 may include less or more number of components. Further, the labels or names of the components are used only for illustrative purpose and does not limit the scope of the invention. One or more components can be combined together to perform same or substantially similar function in the XR apparatus 500).

FIG. 6 shows various hardware components of the object placement controller 540 included in the XR apparatus 500, according to an embodiment as disclosed herein. In an embodiment, the object placement controller 540 includes a 3D occupancy grid controller 610, a ray hit test controller 620, a coverage calculation controller 630, a placement decision controller 640, and an alternate view generation controller 650. The 3D occupancy grid controller 610, the ray hit test controller 620, the coverage calculation controller 630, the placement decision controller 640, and the alternate view generation controller 650 are communicated with each other.

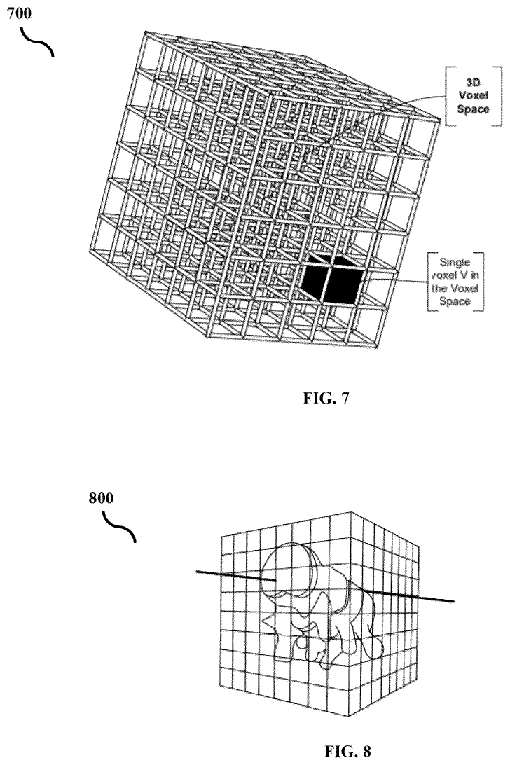

The 3D occupancy grid controller 610 represents the 3D space using a volumetric spatial partitioning of the 3D space. Each voxel in the partition represents whether portion of the 3D object currently lies in that 3D volume. Initially when an XR session begins, the user of the XR apparatus 500 has to give a 360 degree camera view of the space which builds the 3D map based and a 3D spatial partitioning. Initially the vacant space in the real world will correspond to the union of all voxels which are also empty. When the virtual object is being added to the scene, the estimates of the voxel being filled is computed using the mesh coordinates and the camera parameters. Upon estimation, the grid provides an estimate of locations filled with the virtual objects. In an example, the 3D occupancy grid 700 is shown in FIG. 7.

The ray hit test controller 620 represents the 3D space using the volumetric spatial partitioning of the 3D space. Each voxel in the partition currently contains information on whether the volume is occupied by any object or not. When the camera is focused with a particular view direction, the hit test is performed. The hit test is done by performing ray intersection with every cell and checking when the cell is filled or not. The hit test will give the number of cells which are occupied. The disclosed method is a fast and discretized way of finding the occupancy. It is fast because only computation required is finding which voxels fall in the view field of the camera. Once the relevant cells are computed, it is easy of understand the occupancy due to the way the occupancy is saved in the data structure in a Boolean matrix. In an example, a ray hit test 800 is depicted in FIG. 8.

By using the coverage calculation controller 630, the hit test estimates the portion of the camera space which is pre occupied. The number of cells which are marked as filled will be estimated which in turn will give a coverage estimate. If the area covered estimated is more than a threshold, then adding more objects may be prohibited.

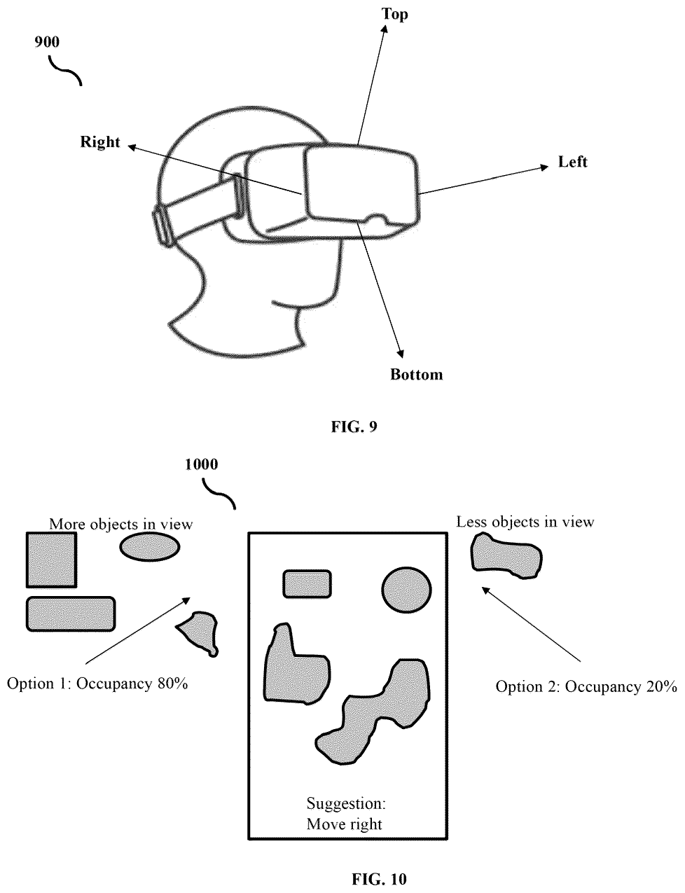

If the object cannot be allocated in current view space, the placement decision controller 640 may provide suggestions of alternate view angles. The alternate views are closer relative to the current position of the user for ease of movement. The best alternate positions would be to move {left, right} or {top, bottom} in that preference order. In order to provide the suggestion, the placement decision controller 640 may have to check the possibility of free space in both cases. There is needed a hard limit on the angle searched too. Hence, the hit test is done for each view direction at discrete angle intervals. In an example, placement decision 900 is depicted in the FIG. 9.

For {left, right} or {top, bottom}, the alternate view generation controller 650 shoots a ray in other angles off from current camera angle, out of camera view space and estimates voxels covered in each case. Further, alternate view generation controller 650 performs the coverage calculation for the possible camera view. Further, the alternate view generation controller 650 evaluates the placement decision and suggests the best angle with minimum reorientation of the camera. Further, the alternate view generation controller 650 finds the best position of camera space free and suggests movement to the user. In an example, the suggestion can be, for example, but not limited to Move left, Move right, Move top or Move bottom.

In an example, the 3D space is represented using the volumetric spatial partitioning of the 3D space. The best alternative position from the current camera direction need to be computed. This is done by hit test of rays originating from neighborhood of current view with the occupancy grid. The hit test is done by performing ray intersection with every cell and checking if it is filled or not. For every candidate ray, its hit test will give the number of cells which are occupied and the area. Based on the computation, the alternate view generation controller 650 computes the occupancy area of every candidate ray, and suggests the user to move to the location which contains minimal intersection. In an example, the ray hit test query for alternate view suggestion 1000 is depicted in FIG. 10.

Although FIG. 6 shows various hardware components of the object placement controller 540 but it is to be understood that other embodiments are not limited thereon. In other embodiments, the object placement controller 540 may include less or more number of components. Further, the labels or names of the components are used only for illustrative purpose and does not limit the scope of the invention. One or more components can be combined together to perform same or substantially similar function in the object placement controller 540).

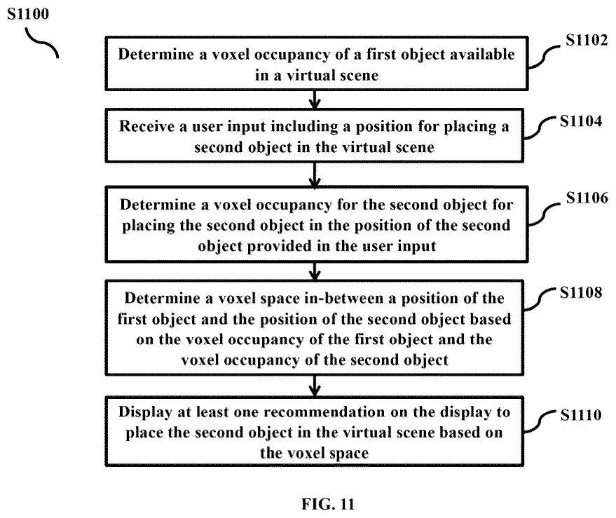

FIG. 11 is a flow chart S1100 illustrating a method for the object placement in the XR environment, according to an embodiment as disclosed herein. The operations S1102-S1110 are handled by the object placement controller 540).

At operation S1102, the method includes determining the voxel occupancy of the first object available in the virtual scene. At operation S1104, the method includes receiving the user input including the position for placing the second object in the virtual scene. At operation S1106, the method includes determining the voxel occupancy for the second object for placing the second object in the position of the second object provided in the user input. At operation S1108, the method includes determining the voxel space in-between a position of the first object and the position of the second object based on the voxel occupancy of the first object and the voxel occupancy of the second object. At operation S1110, the method includes displaying at least one recommendation to place the second object in the virtual scene based on the voxel space.

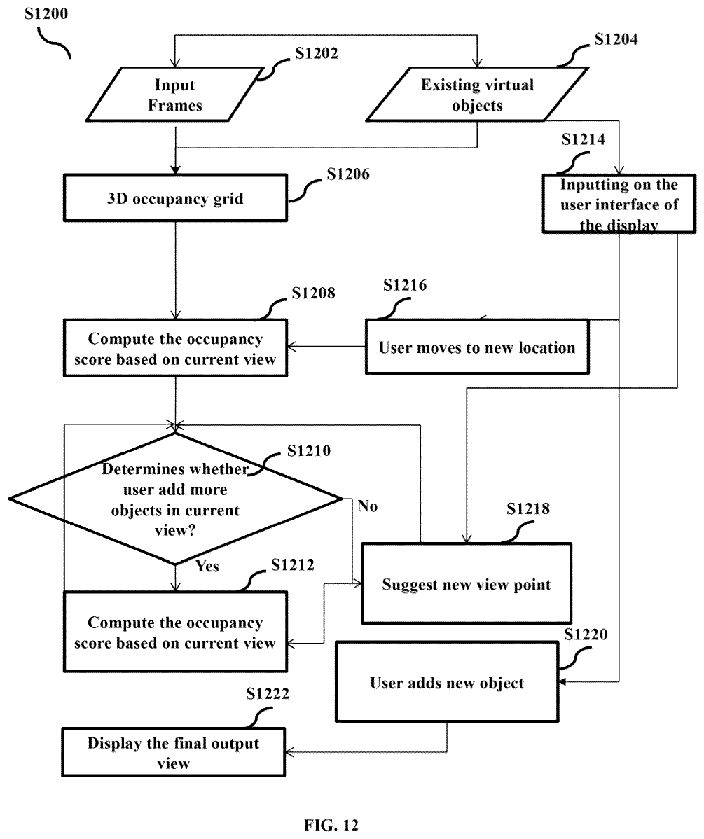

FIG. 12 is an example flow chart S1200 illustrating a method and/or process for the object placement in the XR environment, according to an embodiment as disclosed herein. The operations S1202-S1222 are handled by the object placement controller 540).

At operation S1202, the method includes receiving the input frames. At operation S1204, the method includes receiving the existing virtual objects e.g., furniture, chair, wall or the like. At operation S1206, the method includes determining the 3D occupancy grid based on the input frames and the existing virtual objects. At operation S1208, the method includes computing the occupancy score based on the current view and the user of the XR apparatus 500 moves to the new location. At operation S1210, the method includes determining whether the user of the XR apparatus 500 adds more objects in the current view? In response to determining that the user of the XR apparatus 500 adds more objects in the current view then, at operation S1212, the method includes computing the occupancy score based on the current view and suggesting the new view point based on the input on the user interface at operation S1218.

At operation S1214, the method includes inputting an input on a user interface of the display 550. At operation S1216, the method includes determines that the user of the XR apparatus 500 moves to the new location. At operation S1220, the method includes detects that the user of the XR apparatus 500 adds the new object. At operation S1222, the method includes displaying the final output view based on adding the new object.

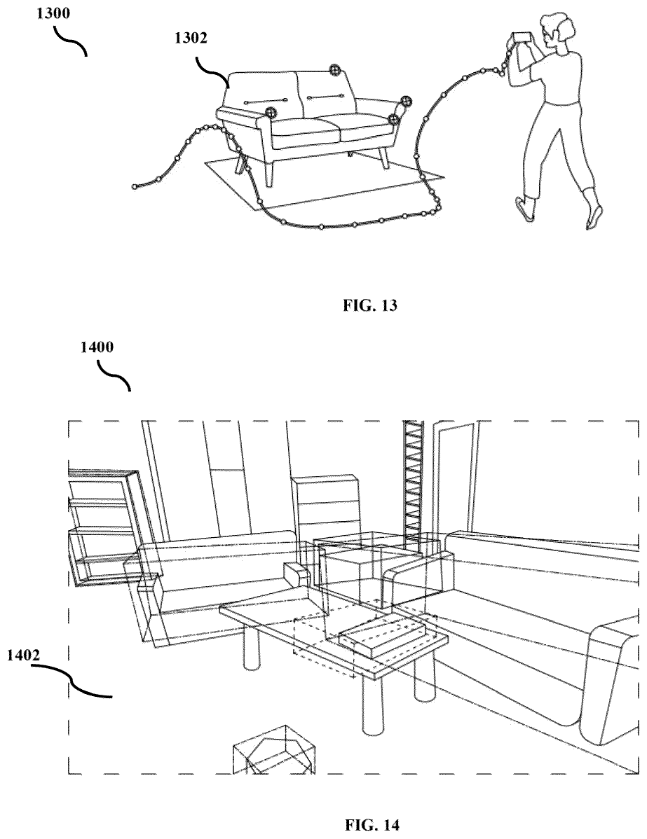

FIG. 13 is an example illustration S1300 in which the user suggestion for the object placement in the virtual space is depicted, according to an embodiment as disclosed herein. Based on the disclosed method, the XR apparatus 100 provides that suggestion to the user as move right to avoid the collision with the furniture 1302).

FIG. 14 is an example illustration S1400 in which walking around scenario, space 1402 is left and few more objects are added in a drawing room, according to an embodiment as disclosed herein.

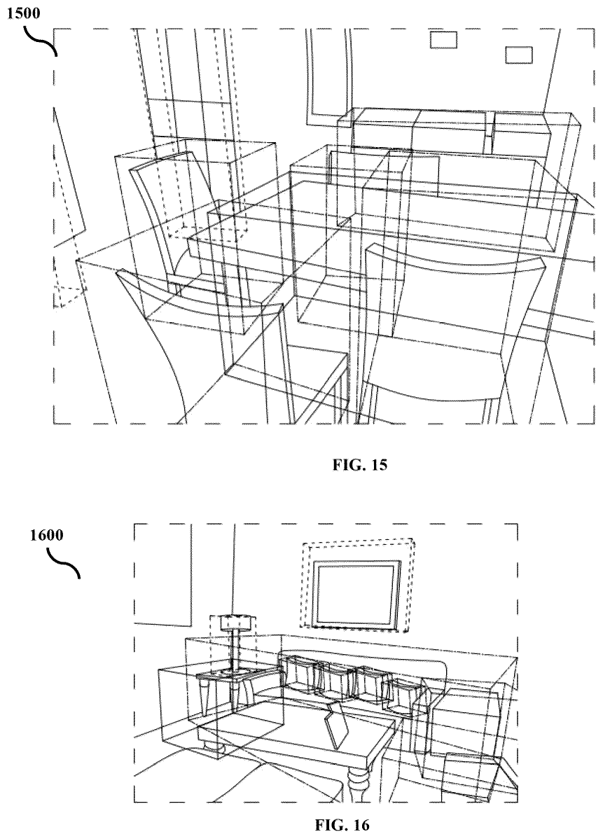

FIG. 15 is an example illustration S1500 in which no space left in current view to add objects in a dining room, according to an embodiment as disclosed herein. FIG. 16 is an example illustration S1600 in which a walking around scenario, no more space is left to add more objects while preserving space to walk around in a drawing room, according to an embodiment as disclosed herein.

The various actions, acts, blocks, steps, or the like in the flow charts S1100 and S1200 may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

What is claimed is:

1. A method for object placement in an extended reality XR environment, the method being executed by at least one processor in a XR apparatus, the method comprising:
determining a voxel occupancy of a first position of a first object available in a virtual scene;
receiving a user input including a second position for placing a second object in the virtual scene;
determining a voxel occupancy for the second object for placing the second object in the second position;
determining a voxel space in-between the first position of the first object and the second position of the second object based on the voxel occupancy of the first object and the voxel occupancy of the second object; and
displaying at least one recommendation to place the second object in the virtual scene based on the voxel space in-between the first position of the first object and the second position of the second object.

2. The method of claim 1, wherein the at least one recommendation comprises at least one alternate position to place the second object and an optimal orientation of the XR apparatus for placement of the second object in the virtual scene.

3. The method of claim 2, wherein the at least one alternate position is beyond a current field of view of the XR apparatus.

4. The method of claim 2, wherein the method comprises displaying a directional indicia indicating the at least one alternate position to place the second object in the virtual scene.

5. The method of claim 1, wherein the displaying the at least one recommendation to place the second object in the virtual scene based on the voxel space comprises:
determining whether the voxel space in-between the first position of the first object and the second position of the second object meets a voxel space threshold;
based on the voxel space in-between the first position of the first object and the second position of the second object meets the voxel space threshold, determining the at least one recommendation to place the second object in the virtual scene based on a category of the second object; and
displaying the at least one recommendation to place the second object in the virtual scene.

6. The method of claim 5, wherein the determining the at least one recommendation to place the second object in the virtual scene based on the category of the second object comprises:
capturing a ray in one or more angles with respect to a current camera angle;
estimating voxels covered in each of the one or more angles;
determining a voxel occupancy for an optimal orientation of the XR apparatus in each of the one or more angles based on the voxels covered in each of the one or more angles; and
determining the at least one recommendation to place the second object in the virtual scene based on voxel occupancy for the optimal orientation of the XR apparatus and the category of the second object.

7. The method of claim 5, wherein the method comprises determining the voxel space threshold using an AI model.

8. The method of claim 7, wherein the method comprises:
determining semantic parameters of a plurality of scenes, semantic parameters of objects in each scene of the plurality of scenes, a type of user interaction with objects in each scene of the plurality of scenes, and a correlation between voxel space and user interaction with objects in each scene of the plurality of scenes; and
training the AI model based on the semantic parameters of the plurality of scenes, the semantic parameters of objects in each scene of the plurality of scenes, the type of user interaction with objects in each scene of the plurality of scenes, and the correlation between voxel space and user interaction.

9. The method of claim 1, wherein the determining the voxel occupancy of the first position of the first object available in the virtual scene comprises:
displaying a 360 degree camera view of the virtual scene;
generating a 3D voxel space based on a 3D spatial partitioning of the 360 degree camera view of the virtual scene, wherein the 3D voxel space comprises a plurality of voxels, and wherein each of the plurality of voxels represents whether at least one portion of the first object lies in the 3D voxel space;
determining mesh coordinates of each voxel of the plurality of voxels and imaging sensor parameters of the XR apparatus; and
determining the voxel occupancy of the first object available in the virtual scene based on the mesh coordinates of each voxel of the plurality of voxels and the imaging sensor parameters of the XR apparatus.

10. The method of claim 1, wherein the determining the voxel occupancy for the second object for placing the second object in the second position comprises:
displaying a 360 degree camera view of the virtual scene;
generating a 3D voxel space based on a 3D spatial partitioning of the 360 degree camera view of the virtual scene, wherein the 3D voxel space comprises a plurality of voxels, and wherein each of the plurality of voxels represents whether at least one portion of the first object lies in the 3D voxel space;
determining a number of voxels of the plurality of voxels that are occupied by the second object in the virtual scene by performing a hit test for each voxel of the plurality of voxels based on the second position of the second object provided in the user input; and
determining the voxel occupancy for the second object in the second position based on the number of voxels that are occupied by the second object in the virtual scene.

11. A XR apparatus for object placement in an virtual environment, comprising:
memory;
at least one processor;
a display; and
an object placement controller, communicatively coupled to the memory, the at least one processor, and the display, configured to:
determine a voxel occupancy of a first position of a first object available in a virtual scene,
receive a user input including a second position for placing a second object in the virtual scene,
determine a voxel occupancy for the second object for placing the second object in the second position,
determine a voxel space in-between the first position of the first object and the second position of the second object based on the voxel occupancy of the first object and the voxel occupancy of the second object, and
display at least one recommendation on the display to place the second object in the virtual scene based on the voxel space in-between the first position of the first object and the second position of the second object.

12. The XR apparatus of claim 11, wherein the at least one recommendation comprises at least one alternate position to place the second object and an optimal orientation of the XR apparatus for placement of the second object in the virtual scene.

13. The XR apparatus of claim 12, wherein the at least one alternate position is beyond a current field of view of the XR apparatus.

14. The XR apparatus of claim 12, wherein the object placement controller is further configured to: displaying a directional indicia indicating the at least one alternate position to place the second object in the virtual scene.

15. The XR apparatus of claim 11, wherein the display of the at least one recommendation to place the second object in the virtual scene based on the voxel space comprises:
determine whether the voxel space in-between the first position of the first object and the second position of the second object meets a voxel space threshold;
based on the voxel space in-between the first position of the first object and the second position of the second object meets the voxel space threshold, determine the at least one recommendation to place the second object in the virtual scene based on a category of the second object; and
display the least one recommendation to place the second object in the virtual scene.

16. A non-transitory computer-readable storage medium storing one or more instructions, that when executed by at least one processor, cause an extended reality XR device to:
determine a voxel occupancy of a first position of a first object available in a virtual scene,
receive a user input including a second position for placing a second object in the virtual scene,
determine a voxel occupancy for the second object for placing the second object in the second position,
determine a voxel space in-between the first position of the first object and the second position of the second object based on the voxel occupancy of the first object and the voxel occupancy of the second object, and
display at least one recommendation on the display 550 to place the second object in the virtual scene based on the voxel space in-between the first position of the first object and the second position of the second object.

17. The non-transitory computer-readable storage medium of claim 16, wherein the at least one recommendation comprises at least one alternate position to place the second object and an optimal orientation of the XR device for placement of the second object in the virtual scene.

18. The non-transitory computer-readable storage medium of claim 17, wherein the at least one alternate position is beyond a current field of view of the XR device.

19. The non-transitory computer-readable storage medium of claim 17, wherein the one or more instructions further cause an extended reality XR device to: displaying a directional indicia indicating the at least one alternate position to place the second object in the virtual scene.

20. The non-transitory computer-readable storage medium of claim 16, wherein the display of the at least one recommendation to place the second object in the virtual scene based on the voxel space comprises:
determine whether the voxel space in-between the first position of the first object and the second position of the second object meets a voxel space threshold;
based on the voxel space in-between the first position of the first object and the second position of the second object meets the voxel space threshold, determine the at least one recommendation to place the second object in the virtual scene based on a category of the second object; and
display the least one recommendation to place the second object in the virtual scene.
